(19) United States
(12) Patent Application Publication
(10) Pub. No.: US 2008/0150361 A1
(43) Pub. Date: Jun. 26, 2008

(54) PLASMA POWER SUPPLY CONTROL SYSTEM AND METHOD

(75) Inventors: Michael Helde, Endingen (DE); Ekkehard Mann, Gundelfingen (DE); Christian Fritsch, Waldkirch (DE)

Correspondence Address: FISH & RICHARDSON PC, P.O. BOX 1022, MINNEAPOLIS, MN, 55440-1022, US

(73) Assignee: HUETTINGER ELEKTRONIK GMBH + CO. KG, Freiburg (DE)

(21) Appl. No.: 11/951,977

(22) Filed: Dec. 6, 2007

(30) Foreign Application Priority Data
Dec. 6, 2006 (DE) 102006057529.6-34

(51) Int. Cl. H02J 3/14

(52) U.S. Cl. 307/31

(57) ABSTRACT

A plasma power supply controller jointly monitors a plurality of plasma power supply devices of one or more electrical loads. The controller includes at least one signal input, at least one signal output connected to at least one first logic switching device configured to actuate a first power interrupter of at least one of the plasma power supply devices, and a safety switching device. The at least one signal input is configured to receive indication signals of at least one indication device. The safety switching device is configured to detect a state or a state change of at least one of the indication devices and to interrupt the current supply of at least one of the plasma power supply devices using the first logic switching device upon a detection of a predetermined state or upon a detection of a state change of at least one of the indication devices.

### CROSS REFERENCE TO RELATED APPLICATION

This application claims priority under 35 U.S.C. §119(a) to German Application No. 10 2006 057 529.6-34, filed on Dec. 6, 2006, the entire contents of which are hereby incorporated by reference.

### TECHNICAL FIELD

The invention relates to a control apparatus for jointly monitoring or controlling a plurality of plasma power supply devices, of one or a plurality of electrical loads, a power supply system, a method for jointly monitoring or controlling a plurality of plasma power supply devices, and a computer program product.

### BACKGROUND

A power supply device such as, for example, a radio-frequency generator (referred to hereinafter as “RF generator”) for industrial applications is conventionally accommodated in a switchgear cabinet provided therefore. By way of example, an RF generator can be used for operating a plasma installation including a plasma chamber. To ensure a sufficient and correct power supply of a plasma chamber, one or more impedance matching devices can be inserted between the RF generator and the plasma chamber. In this way, the signal that is transmitted by the RF generator and that can be changed, for example, by a parasitic impedance of a feed line corresponds to a signal required for plasma generation. The output signal of the impedance matching device represents the input signal of the plasma chamber.

If maintenance work is to be carried out on the plasma chamber, it is necessary to ensure that no signal of the RF generator is fed to the plasma chamber, that is, that no RF voltage is present at an electrode of the plasma chamber. The same applies if maintenance work is to be carried out on one of the impedance matching devices or if one of the impedance matching devices is to be exchanged with another impedance matching device, for example. It is likewise necessary to ensure that, for example, when a switchgear cabinet in which the RF generator is accommodated is opened, the RF generator is free of voltage.

A safety precaution can be implemented by fitting one or a plurality of contacts to doors, flaps, or similar openings of a housing of the plasma chamber, of the RF generator, of the impedance matching device, and/or of the switchgear cabinet of the RF generator. If such a contact is opened, for example, by a door being opened, the current feed of the RF generator can be interrupted. It is thus ensured in a simple manner that no voltage is present in or at the system if, for example, maintenance work or the like is to be carried out.

Ensuring such monitoring of the voltage supply in the case of a multiplicity of RF generators, particularly if groups of RF generators perform different tasks, is conventionally possible by means of a complicated cabling of all the possible electrical components, in particular, of the control contacts and the multiplicity of RF generators.

### SUMMARY

In one general aspect, a plasma power supply controller jointly monitors a plurality of plasma power supply devices of one or more electrical loads. The controller includes at least one signal input, at least one signal output connected to at least one first logic switching device configured to actuate a first power interrupter of at least one of the plasma power supply devices, and a safety switching device. The at least one signal input is configured to receive indication signals of at least one indication device. The safety switching device is configured to detect a state or a state change of at least one of the indication devices and to interrupt the current supply of at least one of the plasma power supply devices using the first logic switching device upon a detection of a predetermined state or upon a detection of a state change of at least one of the indication devices.

Implementations can include one or more of the following features. For example, the at least one first logic switching device can actuate by opening or closing the first power interrupter. The controller can include a further signal output connected to at least one second logic switching device configured to actuate a second power interrupter of at least one of the plasma power supply devices. The least one of the logic switching devices can include an electromagnetic relay. The at least one second logic switching device can actuate by opening or closing the second power interrupter.

The controller can include at least one group of signal outputs, where each signal output of the group of signal outputs includes a signal interrupter, and where the signal interrupters of the group of signal outputs are connected to one another in a positively driven fashion.

The safety switching device can be connected to at least one first logic contact device, and the at least one first logic contact device can be configured to be connected to at least one first power interrupter of at least one plasma power supply device in a positively driven fashion. The safety switching device can include a first logic contact device and a second logic contact device for each group of signal outputs. The safety switching device can be connected to at least one second logic contact device, and the second logic contact device can be configured to be connected to at least a second power interrupter of at least one plasma power supply device in a positively driven fashion.

The safety switching device can be configured to detect a state of the at least one first and/or second logic contact device upon the start-up of the control apparatus and to prevent a state change of the logic switching device upon a detection of a predetermined state of the at least one first and/or second logic contact device. The safety switching device can be configured to prevent a state change of one or more of the signal interrupters of one of the groups of signal outputs upon detection of a predetermined state of the at least one logic contact device. The safety switching device can be configured to selectively select a group of signal outputs and to prevent a state change of the signal interrupters of the selected group of signal outputs upon detection of a predetermined state of the at least one logic contact device.

The controller can include a receiver configured to receive signals from the at least one indication device. The receiver can be configured to receive digital radio signals from the at least one indication device.

In another general aspect, a plasma power supply system includes at least two plasma power supply devices connectable to supply power to at least one electrical load, and a controller configured to jointly monitor the at least two plasma power supply devices. The controller includes at least one signal input, at least one signal output connected to at least one first logic switching device configured to actuate a power interrupter of at least one of the plasma power supply devices, and a safety switching device. The at least one signal input is designed to receive indication signals of at least one indication device. The safety switching device is configured to detect a state or a state change of at least one of the indication devices and to interrupt the current supply of at least one of the plasma power supply devices using the first logic switching device upon detection of a predetermined state or upon a detection of a state change of one of the indication devices.

Implementations can include one or more of the following features. For example, the at least two plasma power supply devices can be RF generators. The at least one first logic switching device can be configured to actuate by opening or closing the first power interrupter.

The controller can include at least one second signal output connected to at least one second logic switching device, where the second logic switching device is configured to actuate a second power interrupter of at least one of the power supplies. The at least one of the logic switching devices can be an electromagnetic relay. The at least one second logic switching device can be configured to actuate by opening or closing the second power interrupter.

The controller can include at least one group of signal outputs, each signal output of the group of signal outputs can have a signal interrupter, and the signal interrupters of the group of signal outputs can be connected to one another in a positively driven fashion. The plasma power supply devices can include a group of plasma power supply devices that each have at least one first power interrupter connected to one another in a positively driven fashion. The safety switching device can have at least one first logic contact device and the first logic contact device can be connected to the first power interrupters of the group of plasma power supply devices in a positively driven fashion. The first power interrupters of the group of plasma power supply devices can be connected to one another and to the first logic interrupting device of the safety switching device in a positively driven fashion in such a way that the first logic interrupting device of the safety switching device is opened in the event of a defective first power interrupter. The safety switching device can have at least one second logic contact device and the second logic contact device can be connected to the second power interrupters of the group of plasma power supply devices in a positively driven fashion. The first logic contact device and the first power interrupters of the group of plasma power supply devices can be connected in a positively driven fashion in such a way that the first power interrupters of the group of plasma power supply devices are closed when the first logic contact device is open. The second logic contact device and the second power interrupters of the group of plasma power supply devices can be connected in a positively driven fashion in such a way that the second power interrupters of the group of plasma power supply devices are closed when the second logic contact device is open.

The safety switching device can be configured to prevent a state change of one or more of signal interrupters of one of the groups of signal outputs upon detection of a predetermined state of the at least one logic contact device. The safety switching device can be configured to selectively select a group of signal outputs and to prevent a state change of the signal interrupters of the selected groups of signal outputs upon detection of a predetermined state of the at least one logic contact device.

The safety switching device can include a first logic contact device and a second logic contact device for each group of signal outputs of the controller.

The plasma power supply system can include a receiver configured to receive signals of the at least one indication device. The receiver can be disposed within a housing of the controller. The signals received can include digital radio signals.

The plasma power supply system can include at least one transmitter configured to transmit signals of the at least one indication device. The transmitted signals can include digital radio signals.

The at least two of the plasma power supply devices can have separate potentials.

The plasma power supply system can include two or more matching devices configured to match a power output of at least one of the plasma power supply devices to the at least one of the electrical loads, where each matching device comprises at least one indication device.

The plasma power supply system can include a matching device designed to match a power output of at least one of the plasma power supply devices to the at least one of the electrical loads, wherein the matching device comprises two or more indication devices.

The safety switching device and the at least one indication device can be connected to one another in such a way that the indication device transmits the state information digitally to the safety switching device. The state information can be transmitted as a digital radio signal. The indication device can be configured to transmit a signal continuously, and the safety switching device can be designed to detect a state change if the transmitted signal is interrupted.

The plasma power supply system can include a power load including at least one electrode of a plasma chamber. The power load can include two or more electrodes of a plasma chamber.

The plasma power supply system can include a power load comprising a laser. The laser can be a CO2 laser.

The plasma power supply system can include two or more impedance matching devices configured to match output signals of the two or more RF generators in such a way that the output signals are matched as input signals of a plasma chamber comprising one or more electrodes for plasma generation.

In another general aspect, a plurality of plasma power supply devices are jointly monitored by monitoring a state of at least one indication device, detecting a predetermined state and/or a state change of the at least one indication device with a safety switching device, changing the state of a first logic switching device by means of the safety switching device if a predetermined state and/or a state change of the at least one indication device has been detected, and changing a state of a power interrupter of at least one of the plasma power supply devices on the basis of the state change of the first logic switching device such that a current supply of at least one of the plasma power supply devices is interrupted.

In another general aspect, a computer program product, which, when loaded in and executed by a computer, causes a computer to jointly monitor a plurality of plasma power supply devices by monitoring a state of at least one indication device, detecting a predetermined state and/or a state change of the at least one indication device with a safety switching device, changing the state of a first logic switching device by means of the safety switching device if a predetermined state and/or a state change of the at least one indication device has been detected, and changing a state of a power interrupter of at least one of the plasma power supply devices on the basis of the state change of the first logic switching device such that a current supply of at least one of the plasma power supply devices is interrupted.

A power supply of an electrical load, such as a plasma chamber, for example, can be monitored or controlled with a control apparatus of a power supply system, and a method performed by the control apparatus.

In one general aspect, a control apparatus jointly monitors or controls a plurality of plasma power supply devices, in particular, at least two RF generators, of one or more electrical loads. The control apparatus includes at least one signal input, where the at least one signal input is designed to receive indication signals of at least one indication device,

and at least one signal output connected to at least one first logic switching device designed to open and/or to close a first power interrupter of at least one of the plasma power supply devices. The control apparatus also includes a common logic device that is designed to detect a state or a state change of at least one of the indication devices and to interrupt the current supply of at least one of the plasma power supply devices by means of the first logic switching device upon a detection of a predetermined state or upon a detection of a state change of at least one of the indication devices.

In this way, two or more indication devices, such as conventional electrical contacts, for example, whose state changes when a door is opened or when a flap is opened, etc., can be monitored by means of a single control apparatus. A state change can be, for example, an opening of a closed contact or a closing of an opened contact. Such a state change can be detected by the control apparatus. When a state is ascertained, the state of the logic switching device is also changed. By way of example, an unoperated logic switching device can now be operated on account of current feed. As an alternative, the current feed of a logic switching device that is in operation can also be interrupted. The logic switching device is designed in such a way that a current supply of one or all of the plasma power supply devices is interrupted by the state change. By way of example, one or more of the plasma power supply devices, such as one or a plurality of RF generators, for example, can have a switch that reacts to an alteration of the state of the logic switching device, or the logic switching device can be designed correspondingly. In this case, the logic switching device can be an electromagnetic relay device. In particular, the logic switching device can be a so-called conventional “auxiliary contactor switch” or be part of such an “auxiliary contactor switch”. The signal output can be connected to precisely one first logic switching device. The signal output can also be connected to two or more first logic switching devices. The signal output can preferably be referred to as first signal output.

Advantageously, it is possible to interrupt the current supply of a plurality of plasma power supply devices using a single control apparatus, in particular, by means of a single first logic switching device of the control apparatus. In other words, by means of a single first relay, for example, a so-called “auxiliary contactor switch”, a plurality of plasma power supply devices, such as RF generators for example, can be disconnected from their current feed.

Indication devices can be, for example, door contacts of one or more RF generators, contacts at accesses to a plasma chamber or contacts at opening possibilities of current sources, such as DC current sources and/or AC current sources. An indication device can also be a contact in a switching enclosure of the plasma power supply devices, etc. It is advantageously possible for a plurality of indication devices, such as a plurality of switching contacts, for example, to be jointly monitored by means of one unit.

The indication signals of the indication devices can be transferred to the control apparatus through one or more signal inputs. By way of example, a plurality of electrical monitoring switches, as described above, can be connected in series with one another and be connected to a signal input of the control apparatus. In other words, the indication contacts or the indication signals thereof are preferably collected at one signal input.

The preferred control apparatus thus advantageously permits operator protection, particularly in the case of plasma installations having a plurality of supply devices, such as, for example, one or a plurality of RF generators, DC current sources, impedance matching devices, etc.

The control apparatus can have a further signal output connected to at least one second logic switching device designed to open and/or to close a second power interrupter of at least one of the plasma power supply devices.

The further signal output can be connected to one second logic switching device. The further signal output, that is, the second signal output, can also be connected to two or more second logic switching devices.

The control apparatus can have at least one group of signal outputs. Each signal output of the group of signal outputs can have a signal interrupter, and the signal interrupters of the group of signal outputs can be connected to one another in a positively driven fashion.

The expression “in a positively driven fashion” within the meaning of the invention analogously encompasses the fact that, for example, two or more electrical switches are mechanically and/or electrically connected to one another in such a way that in the event of a state change of one of the switches, a state change of the other, remaining switches is likewise brought about. In other words, a first switch can be open, in which case the second, third, etc. switch can also likewise be open. If the first switch is closed, the second, third, etc. switch is also closed. As an alternative, the first switch can be open and a further switch, namely, the switch connected to the first switch in a positively driven fashion, can be closed. If the first switch is opened, the further switch is consequently closed on account of the positively driven connection. This can apply analogously to any desired number of switches. By way of example, three, four, five, etc. switches can be connected to one another in a positively driven fashion, where one subset of the switches can have an open state and one subset of the switches can have a closed state. As an alternative, it is also possible for all the switches to be open or all the switches to be closed. Thus, in general, if a first element is connected to a second element in a positively driven fashion then the first element and the second element are driven in dependence on one other such that if the first element has a state change, then the second element is caused to have a state change, or if the second element has a state change, then the first element is caused to have a state change.

If, for example, a first electrical switch is situated in the current feed of a first device, for example, of a first plasma power supply device, and a second electrical switch is situated in a current feed of a second device, for example of a second plasma power supply device, the two switches can be connected in a positively driven fashion. In particular, this can be effected in such a way that the first switch is open if the second switch is also open. If the first switch is closed, the second switch is also closed. Alternatively, if the second switch is closed, then the first switch is also closed. The connection can be, for example, a simple mechanical connection. The two switches can be connected, e.g., via a link, a clip, etc. The connection can also be an electrical, in particular, electromagnetic connection, for example by means of an electromagnet.

In some implementations, the output signal is duplicated on the basis of the at least two signal outputs. This is achieved by means of the positively driven signal interrupters. In this case, the signal interrupters can be simple electrical switches or contacts that are connected to one another in positively driven fashion in such a way that all the switches have the same state.

In other words, the information that a state of an indication device has changed, for example, is transmitted to a plurality of switches or transmitted to a plurality of signal outputs. This corresponds to a duplication of the indication signals or the state of an indication device.

Preferably, a signal output can also have a plurality of signal interrupters. For example, the first signal output can have a first signal interrupter, a second signal interrupter, a third signal interrupter, etc. The second signal output can likewise have a first signal interrupter, a second signal interrupter, a third signal interrupter, etc. The first signal interrupters are preferably connected to one another in each case in a positively driven fashion. Likewise, the second signal interrupters are preferably connected to one another in each case in a positively driven fashion, the third signal interrupters are preferably connected to one another in each case in a positively driven fashion, etc.

A group of signal outputs can be for example a subset of the total set of signal outputs.

Preferably, the logic device is connected to at least one logic contact device, where the at least one logic contact device can be connected to at least one first power interrupter of at least one plasma power supply device in a positively driven fashion.

The logic device is furthermore preferably connected to at least one second logic contact device, where the second logic contact device can be connected to a second power interrupter of at least one plasma power supply device in positively driven fashion.

In other words, a mechanical connection can preferably be producible between the first logic contact device and the first power interrupter of a plasma power supply device. If the state of the first logic contact device, for example, of an electrical switch, is changed, the state of the first power interrupter of the plasma power supply device is also changed. In particular, it is possible for the first logic contact device to be open if the first power interrupter is closed. If the first power interrupter is open, the first logic contact device is simultaneously closed. In the event of a malfunction, in particular, if the first power interrupter of the power supply remains closed on account of a defect, that is, that the current supply of the plasma power supply device continues to be closed on account of the defective power interrupter, the first logic contact device remains open.

In addition, the second logic contact device can preferably also be mechanically and/or electrically connected to a second power interrupter of the plasma power supply device. Consequently, a state change of the second logic contact device is simultaneously accompanied by a state change of the second power interrupter. In addition, it is also possible to provide a plurality of logic contact devices, in particular a third, a fourth, etc. logic contact device, which can be electrically connected to the logic device. It is likewise possible to provide further power interrupters, for example, a third, a fourth, etc. power interrupter of the power supply. In particular, the logic contact devices are connected in series and connected to an input and an output of the logic device.

The logic device is furthermore preferably designed to detect a state of the at least one logic contact device upon the start-up of the control apparatus and to prevent a state change of the logic switching device upon a detection of a predetermined state of the at least one logic contact device.

In other words, the logic device can be designed in such a way that the logic device prevents a signal output to the one or the plurality of logic switching devices if at least one logic contact device does not have a predefined state. In other words, by way of example, the logic switching device can be activated only when all the logic devices are closed. Since the logic contact devices can furthermore preferably be connected to corresponding power interrupters of the power supply in positively driven fashion, the assigned power interrupters must consequently be open. Should one of the power interrupters remain closed, for example, on account of a defect, the logic contact device that can be connected thereto remains open. The logic device thus prevents an activation of the one or the plurality of logic switching devices. Consequently, the remaining power interrupters of the plasma power supply device are not closed. Since operation of the plasma power supply device is preferably only possible if all the power interrupters are closed, the plasma power supply device is advantageously not operable.

Particularly preferably, the logic device is designed to prevent a state change of one or a plurality of signal interrupters of one of the groups of signal outputs upon a detection of a predetermined state of the at least one logic contact device.

In other words, as explained above, it is possible to prevent the activation or the turn-off of a logic switching device on account of a state of one or a plurality of the logic contact devices. This can be done, for example, by virtue of the fact that, on account of the logic device, one or a plurality of signal interrupters remain open or remain closed if the logic device detects a predetermined state of one or a plurality of the logic contact devices. The same applies if the logic device detects a predetermined signal at the connection of the logic contact device(s) to the logic device, for example, if a test current having a predetermined current intensity is or is not present.

Particularly preferably, the logic device is designed, upon a detection of a predetermined state of the at least one logic contact device, to selectively select a group of signal outputs and to prevent a state change of the signal interrupters of these groups of signal outputs.

By way of example, in addition to the logic contact devices described above, an additional pair of logic contact devices can be connected to the logic device by means of further inputs or connecting locations. Likewise, the control apparatus can preferably have further signal outputs. The further signal outputs can preferably be driven by the logic device separately from the signal outputs described previously. The further signal outputs or the group of signal outputs can have signal interrupters which can be driven by the logic device separately from the above-mentioned signal interrupters. The further signal interrupters can be positively driven, in particular. If the further logic contact devices do not have a predetermined state, for example, the signal interrupters for example can remain in an open state. If, by contrast, the further logic contact devices have a predetermined state, the further signal interrupters are closed and a signal is provided at the corresponding, further signal outputs.

Further logic switching devices can be connected to the further signal outputs. These further logic switching devices could serve for turning further plasma power supply devices on and off. By way of example, the above-mentioned plasma power supply devices could be RF generators. The further plasma power supply devices could be DC current sources. The power interrupters of the RF generators can be connectable to the above-mentioned logic contact devices in positively driven fashion. The further logic contact devices can be connectable to the power interrupters of the DC current sources in a positively driven fashion. Consequently, should there be a defect in one or a plurality of the RF generators or in the corresponding power interrupters, the RF generators can be selectively excluded from further operation. The DC current sources, by contrast, in which there is no defect present, can continue to be operated.

Correspondingly, further signal inputs that combine different indication contacts can preferably be provided. The logic device can preferably be designed to generate output signals according to the indication signals input, that is, depending on the signal input at which the indication signals arrive, and, for example, to selectively drive groups of signal outputs for signal outputting. Therefore, depending on the indication signals, groups of plasma power supply devices can be selectively excluded from operation.

In particular, indication signals of a group of identical devices can be input at a first signal input. By way of example, indication signals from indication contacts of the plasma chamber can be input at a first signal input. Indication signals from indication contacts of the RF generators can arrive at a second signal input, etc.

The logic device, for each group of signal outputs, can include a first logic contact device and a second logic contact device.

In other words, a pair of logic contact devices (a first logic contact device and a second logic contact device) is provided for each group of signal outputs. If, for example, two, three, four, etc. groups of signal outputs are present, two, three, four, etc. pairs of logic contact devices are also connected to the logic device. The pairs of logic contact devices are in this case each connected to the logic device independently of one another. Consequently, the first pair of logic contact devices is connected by itself to the logic device. The second pair of logic contact devices is connected to the logic device separately from the first pair of logic contact devices, etc. The group of signal devices can also include three, four, five, etc. signal outputs. Three, four, five, etc. logic contact devices are correspondingly provided for this group.

The control apparatus can include a receiver designed to receive signals of the at least one indication device, in particular, digital radio signals.

The receiver can be connected, in particular, to at least one signal input of the control apparatus. The receiver can be designed, for example, to receive radio signals, infrared signals, Bluetooth signals, LAN signals, WLAN signals, etc. As alternative or in addition, the signal input, that is to say in particular the receiver, can be designed to receive the indication signals “directly” or “in digitized fashion” by means of a copper cable. As an alternative/in addition, the signal input, in particular, the receiver, can be designed to receive the indication signals as light signals from an optical waveguide.

At least one of the logic switching devices is furthermore preferably an electromagnetic relay device.

In another general aspect, a power supply system includes a plurality of plasma power supply devices, in particular, at least two RF generators, for at least one electrical load, and a control apparatus for jointly monitoring or controlling the at least two plasma power supply devices. The control apparatus has at least one signal input, where the at least one signal input is designed to receive indication signals of at least one indication device, at least one signal output connected to at least one first logic switching device designed to open and/or to close a power interrupter of at least one of the plasma power supply devices, and a common logic device. The common logic device is configured to detect a state or a state change of each indication device and to interrupt the current supply of at least one of the plasma power supply devices by means of the first logic switching device upon a detection of a predetermined state or upon a detection of a state change of one of the indication devices.

The power interrupters can be, for example, conventional switches or contacts. The power interrupters can also be relay-controlled switches.

The control apparatus has at least one second signal output connected to at least one second logic switching device, and the second logic switching device is designed to open and/or to close a second power interrupter of at least one of the power supplies.

The control apparatus furthermore has at least one group of signal outputs, where each signal output of the group of signal outputs has a signal interrupter and the signal interrupters of the group of signal outputs are connected to one another in a positively driven fashion.

The plasma power supply device can have a group of plasma power supply devices, where each plasma power supply device has at least one first power interrupter and the first power interrupters of the plasma power supply devices are connected to one another in a positively driven fashion.

In some implementations, the logic device has at least one first logic contact device and the at least one first logic device is connected to the first power interrupters of the group of plasma power supply devices in a positively driven fashion.

In other implementations, the logic device has at least one second logic contact device and the at least one second logic contact device is connected to the second power interrupters of the group of plasma power supply devices in a positively driven fashion.

The first logic contact device of the logic device and the first power interrupters of the group of plasma power supply devices can be connected in a positively driven fashion in such a way that when the first logic contact device of the logic device is open, the first power interrupters of the group of plasma power supply devices are closed, and/or the second logic contact device of the logic device and the second power interrupters of the group of plasma power supply devices are connected in positively driven fashion in such a way that when the second logic contact device of the logic device is open, the second power interrupters of the group of plasma power supply devices are closed.

The logic device can be configured, upon a detection of a predetermined state of the at least one logic contact device, to prevent a state change of one or a plurality of signal interrupters of one of the groups of signal outputs.

The logic device can be configured, upon a detection of a predetermined state of the at least one logic contact device, to selectively select a group of signal outputs and to prevent a state change of the signal interrupters of these groups of signal outputs.

The logic device, for each group of signal outputs, can include a first logic contact device and a second logic contact device.

The power supply system can be embodied with a receiver designed to receive signals of the at least one indication device, in particular digital radio signals.

The power supply system can include at least one transmitting device designed to transmit signals of the at least one indication device, in particular digital radio signals.

At least two of the plasma power supply devices can have separate potentials.

The power supply system can include two or more matching devices designed to match a power output of at least one of the plasma power supply devices to the at least one of the electrical loads, where each matching device includes at least one indication device, and/or the power supply system can include a matching device designed to match a power output of at least one of the plasma power supply devices to the at least one of the electrical loads, wherein the matching device includes two or more indication devices.

The first power interrupters of the group of plasma power supply devices can be connected to one another and to the first logic interrupting device of the logic device in a positively driven fashion in such a way that the first logic interrupting device of the logic device is opened in the event of a defective first power interrupter.

The logic device and the at least one indication device can be connected to one another in such a way that the indication device transmits the state information digitally, preferably as a digital radio signal, to the logic device.

The at least one indication device is furthermore preferably designed to transmit a signal continuously, and the logic device is designed to detect a state change if the signal is interrupted.

The power supply system can have a power load, where the power load includes at least one electrode of a plasma chamber.

The power load can include two or more electrodes of a plasma chamber.

The power supply system can include a power load having a laser, for example, a CO₂ laser.

The power supply system furthermore can include two or more impedance matching devices designed to match output signals of the two or more RF generators in such a way that they are matched as input signals of a plasma chamber comprising one or more electrodes for plasma generation.

At least one of the logic switching devices can be an electromagnetic relay device.

In another general aspect, a plurality of plasma power supply devices, for example, at least two RF generators, are jointly monitored and controlled. A state of at least one indication device is monitored, a predetermined state and/or a state change of the at least one indication device is detected by means of a logic device. The state of a first logic switching is changed by means of the logic device if a predetermined state and/or a state change of the at least one indication device has been detected. A state of a power interrupter of at least one of the plasma power supply devices, for example, of each RF generator, is changed on the basis of the state change of the first logic switching device, such that a current supply of at least one of the plasma power supply devices, in particular, of the two RF generators, is interrupted.

The method is configured to monitor or to control the current feed of the at least two plasma power supply devices.

The method preferably includes a step of detecting a state of a logic circuit. The logic circuit includes, for example, two or more logic contact devices. Consequently, it can be ascertained whether at least one logic contact device is open.

The method can include a step of preventing a signal outputting, for example, by interrupting the signal outputting, at least one of the signal outputs if the state of at least one of the logic contact devices has been detected as open. This can be done by interrupting a circuit.

The step of detecting a state of a logic circuit is furthermore preferably carried out repeatedly, particularly if the operation of the at least one plasma power supply device is started. In other words, the detection of a state of a logic circuit is carried out whenever the current feed of at least one plasma power supply device is activated or is intended to be activated.

In another general aspect, a computer program product, in particular, stored on a computer-readable medium or realized as a signal, which, when loaded in and executed by a computer, has the effect that the computer carries out a method according to the invention.

The above description of the aspects of the invention is not restricted to the respective aspects. Rather, the explanations concerning the respective aspects analogously apply to the further aspects of the invention. In particular, the embodiments with regard to the control apparatus or preferred embodiments of the control apparatus apply analogously to the power supply system, the method and the computer program product.

### DESCRIPTION OF THE DRAWINGS

FIG. 1 is a schematic view of an implementation of a power supply system for a plasma chamber;

FIG. 2 is a schematic view of another implementation of a power supply system for a plasma chamber;

FIG. 3 is a schematic view of another implementation of a power supply system for a plasma chamber; and

FIG. 4 is a diagram of a circuit of a power supply device having a control apparatus.

### DETAILED DESCRIPTION

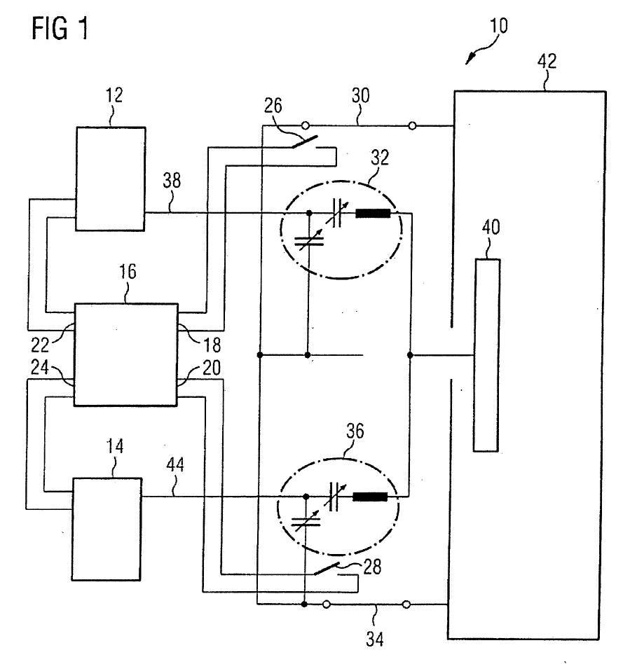

FIG. 1 shows a power supply system 10 such as a vacuum plasma system. The vacuum plasma system 10 includes plasma power supply devices including a first radio-frequency (RF) generator 12 and a second RF generator 14 that supply power to one or more electrodes 40 within a plasma chamber 42. The first RF generator 12 produces a signal output 38, for example, of 13.56 MHz. The second RF generator 14 produces a signal output 44, for example, of 3.39 MHz. The vacuum plasma system 10 also includes a control apparatus such as an “interlock distributor box” 16. The interlock distributor box 16 has signal inputs 18, 20 and signal outputs 22, 24. The signal inputs 18, 20 are connected to indication devices such as indication contacts or switches 26, 28. The terms “switch” and “contact” are used synonymously within the meaning of this invention. In this case, contacts or switches that close a circuit are referred to as “make contacts” and contacts or switches that open a circuit are referred to as “break contacts”.

The indication contact 26 can be connected, for example, to a covering 30 of an impedance matching device such as a so-called “matchbox,” which is represented by way of example by circuit 32 and which feeds into the plasma chamber 42. If the covering 30 is opened, for example, the indication contact 26 is also opened, that is, a current flow through the indication contact 26 is prevented. The indication contact 26 is an exemplary “break contact”. A current flow through the signal input 18 is not possible when the indication contact 26 is opened, and the current flow through the signal input 18 can be detected by the interlock distributor box 16. By way of example, a small auxiliary current can flow through the indication contact 26, 28 and the auxiliary current can be monitored or detected by the interlock distributor box 16. If an auxiliary current no longer flows since the indication contact 26 or 28 is open, this can be detected by means of the interlock distributor box 16.

A covering 34 of a second “matchbox” is represented in an analogous manner. The second matchbox is represented by way of example by a circuit 36. If the cover 34 is open, the indication contact 28 is also open, whereby a current flow through the indication contact 28 is no longer possible, and this current flow can be detected by the interlock distributor box 16. In this case, as in the case of the signal input 18, a current flow through the signal input 20 is not possible since the indication contact 28 is open and this lack of current flow can be detected by the interlock distributor box 16.

As soon as the interlock distributor box 16 detects that either or both of the indication contacts 26 and 28 are open, the interlock distributor box 16 outputs a signal through the respective signal output 22 and 24. The current supply of the respective RF generator 12 and 14 is interrupted on the basis of the output signal from the interlock distributor box 16. In another implementation, the signal outputs 22, 24 are embodied as a single signal output. Consequently, both the RF generators 12, 14 can be disconnected from a current input feed (for example, from a mains supply system) upon detection of an open indication contact 26, 28. If, by way of example, the RF generator 12 is disconnected from the mains supply system, a signal can no longer be communicated through the output 38 to the electrode 40 of the plasma chamber 42 or a voltage is no longer applied to the electrode 40 by means of the RF generator 12. In other words, as soon as the covering 30 is open, the voltage is prevented from being applied within the plasma chamber 42 in or in proximity to which the matchbox 32 is arranged. Thus, maintenance personnel who open the plasma chamber 42 for maintenance purposes using the covering 30 are protected against injuries or damage to health due to electric shocks caused by voltage/current from the RF generator 12. She same applies in an analogous manner if the covering 34 is opened. In this case, the current supply of the RF generator 14 is interrupted and no current can flow through the output 44 into the electrode 40 of the plasma chamber 42. In other words, a current flow into the plasma chamber 42 is prevented. Within the meaning of this application, the above-mentioned term “signal” is synonymous with the term “electromagnetic signal”, in particular with (high) voltage and/or (high) current flow.

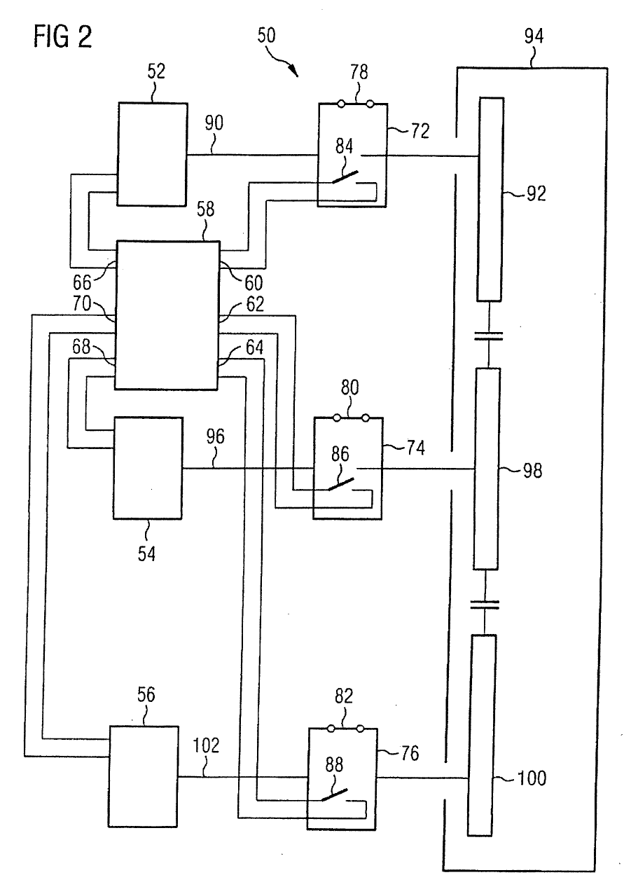

FIG. 2 shows, analogously to FIG. 1, a power supply system such as a vacuum plasma system 50 that supplies power to one or more electrodes 92, 98, 100 of a plasma chamber 94. The vacuum plasma system 50 includes a first RF generator 52, a second RF generator 54, and a third RF generator 56. Furthermore, the vacuum plasma system 50 includes an interlock distributor box 58. The interlock distributor box 58 has signal inputs 60, 62, 64 and signal outputs 66, 68, 70. Furthermore, FIG. 2 illustrates matchbox 72, matchbox 74, and matchbox 76, where matchbox 72 has a covering 78, matchbox 74 has a covering 80, and matchbox 76 has a covering 82. Furthermore, an indication contact 84 is arranged in the matchbox 72, an indication contact 86 is arranged in the matchbox 74, and an indication contact 88 is arranged in the matchbox 76. The signal inputs 60, 62, 64 can be combined to form one signal input.

If the covering 78 of the matchbox 72 is opened, the indication contact 84 opens, and the interlock distributor box 58 can detect this. In particular, a current flow through the signal input 60 is not possible because the indication contact 84 is opened, and this lack of current flow can likewise be detected by the interlock distributor box 58. Correspondingly, the interlock distributor box 58 can output to the signal output 66 a signal that interrupts the current supply of the RF generator 52. Consequently, no RF voltage is output through an output 90 of the RF generator 52 through the matchbox 72 to the electrode 92 of the plasma chamber 94, or no current flows through the output 90. The RF generators 54, 56 can continue to be operated, for example, independently of the effective shut off of the RF generator 52.

If the covering 80 of the matchbox 74 is opened, the indication contact 86 opens, correspondingly through signal input 62 a signal is generated in the interlock distributor box 58, a corresponding signal is communicated by the signal output 68 to the RF generator 54, for example, and RF generator 54 is not operated any further. Consequently, this also prevents an RF voltage from being applied to the electrode 98 of the plasma chamber 94 by means of an output 96 through the matchbox 74. In addition, a signal can also be sent to the RF generator 56 by means of the signal output 70, on account of which signal the operation of the RF generator 56 is interrupted. Consequently, there is also no voltage present at the electrode 100 of the plasma chamber, which is connected to the RF generator 56 through an output 102 of the RF generator 56.

As an alternative, it is also possible for the operation of all the RF generators 52, 54, 56 to be interrupted upon the opening of only one or two of the coverings 78, 80, 82. This means that a voltage flashover from an operated electrode 92, 98, 100 cannot take place, which means that it is also impossible for there to be a voltage flashover between the individual electrodes 92, 98, 100.

Furthermore, a further indication contact (not shown) can be arranged at a covering 95 of the plasma chamber 94, and, upon the opening of the covering, one or a plurality of the RF generators 52, 54, 56 can no longer be supplied with current.

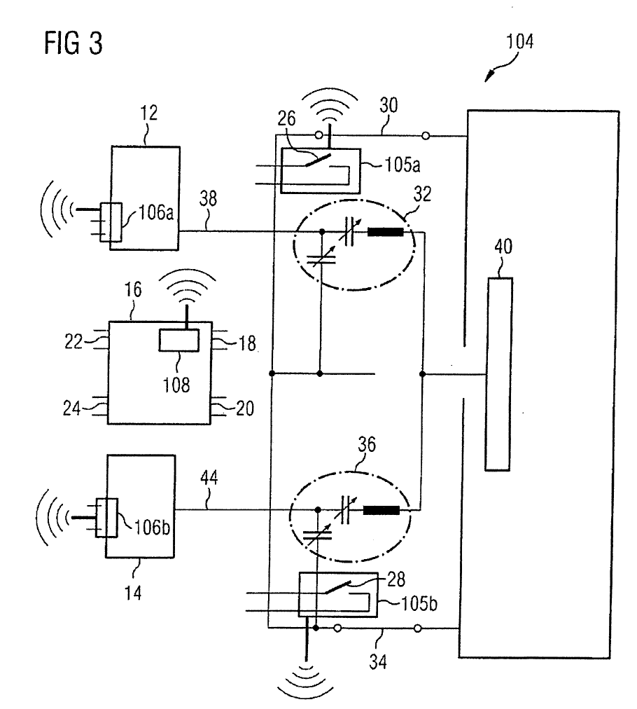

FIG. 3 shows a vacuum plasma system 104 similar to the vacuum plasma system 10 shown in FIG. 1. The vacuum plasma system 104 includes transmitting devices 105a, 105b and receiving devices 106a, 106b. Furthermore, the vacuum plasma system 104 includes a central master transceiver 108. In this case, the central master transceiver 108 is preferably in signal interchange with the interlock distributor box 16. In particular, the central master transceiver 108 can replace one or more of the signal inputs 18, 20 and/or one or more of the signal outputs 22, 24 (shown in FIG. 1) of the interlock distributor box 16. Consequently, the interlock distributor box 16 can be in signal interchange with elements of the vacuum plasma system 104 through the master transceiver 108.

By way of example, the central master transceiver 108 can receive wireless signals from the transmitting devices 105a, 105b. In this case, the transmitting devices 105a, 105b can be in contact with one or more of the indication contacts 26, 28 and therefore the transmitting devices 105a, 105b can communicate a state or a state change of one or more of the indication contacts 26, 28 to the central master transceiver 108. In particular, the signal transmission to and from the transceiver 108 can be carried out using radio, WLAN, Bluetooth, infrared, etc. In this case, the indication contacts 26, 28 can be provided with a dedicated power supply (not shown) and/or be connected to the power supply of, for example, one of the matchbox circuits 32, 36.

Furthermore, FIG. 3 illustrates the receiving devices 106a, 106b. The receiving devices 106a, 106b are, for example, in signal interchange with the central master transceiver 108 by way of a wireless signal transmission. If, for example, the interlock distributor box 16 ascertains that a state change of one of the indication contacts 26, 28 has taken place, a corresponding signal can be communicated to one or more of the receiving devices 106a, 106b through the central master transceiver 108. The operation of one or more of the RF generators 12, 14 is thereupon interrupted. In addition or as an alternative, one or more of the RF generators 12, 14 can be provided with dedicated indication contacts (not shown) that are in signal interchange with the central master transceiver 108 through dedicated transmitting devices (not shown). If, for example, a state change of an indication contact (not shown) of the RF generator 12 occurs, a corresponding signal is communicated to the central master transceiver 108 and evaluated by the interlock distributor box 16. Correspondingly, a signal can be communicated to one or more of the RF generators 12, 14, or the receiving devices 106a, 106b thereof, by means of the central master transceiver 108, such that the operation of one or more of the RF generators 12, 14 is interrupted. The signal interchange between the RF generators 12, 14 and the central master transceiver 108 can also be carried out using the receiving devices 106a, 106b. In other words, one or more of the receiving devices 106a, 106b can also be designed to transmit signals. It is therefore possible to communicate signals from one or more of indication contacts (not shown) of the RF generators 12, 14 to the central master transceiver 108 by means of the receiving device(s) 106a, 106b.

In other words, the central master transceiver 108 can replace the signal outputs 22, 24 and signal inputs 18, 20 of the interlock distributor box 16. Analogously, the transmitting devices 105a, 105b and the receiving devices 106a, 106b can replace the signal lines between the indication contacts 26, 28 and the interlock distributor box 16 and the signal lines between the RF generators 12, 14 and the interlock distributor box 16.

The central master transceiver 108 can be, for example, an integral part of the interlock distributor box 16. The central master transceiver 108 can, for example, be integrated during the production of the interlock distributor box 16. As an alternative, the interlock distributor box 16 can also be retrofitted with a central master transceiver 108. In this case, the central master transceiver 108 can be connected in terms of signaling technology to the signal inputs 18, 20 and the signal outputs 22, 24 of the interlock distributor box 16. Analogously, one or more of the indication contacts 26, 28 or of the matchboxes 72, 76 (shown in FIG. 2) can also be retrofitted with transmitting devices 105a, 105b or correspondingly exchanged. The RF generators can likewise be subsequently equipped with receiving devices 106a, 106b.

The vacuum plasma system 104 as shown in FIG. 3 can therefore be identical to the vacuum plasma system 10 shown in FIG. 1, with the exception that the signal interchange between the indication contacts 26, 28 and the interlock distributor box 16 and the RF generators 12, 14 is wireless. Correspondingly, the signal interchange in the vacuum plasma system 50 as shown in FIG. 2 can also be wireless by using corresponding transmitting devices and receiving devices.

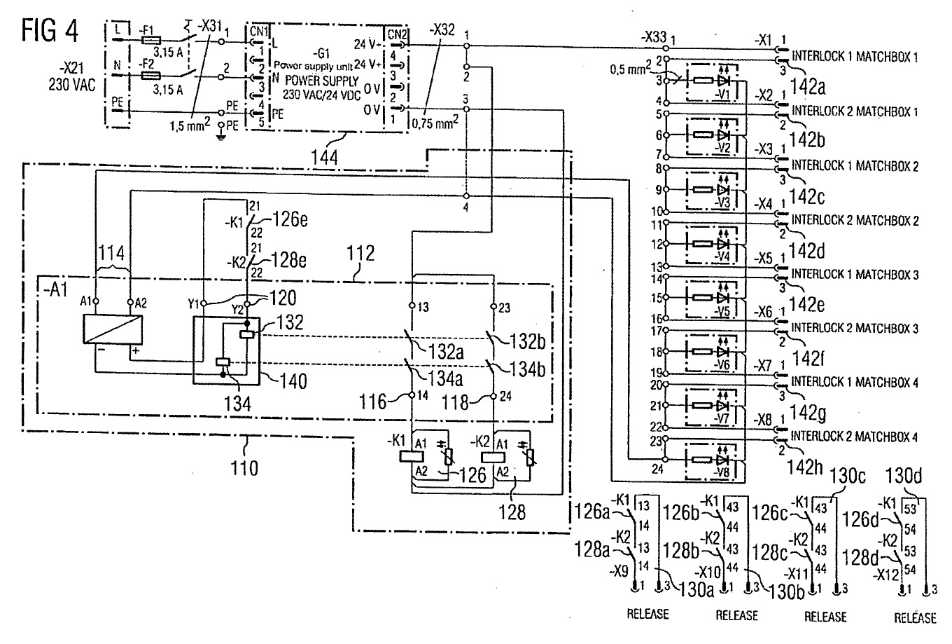

FIG. 4 shows an exemplary circuit diagram of a vacuum plasma system including RF generators 130a, 130b, 130c, 13d connected to a control apparatus 110 (for example, the interlock distributor box 16). The control apparatus 110 includes a logic device such as a conventional safety switching device 112. The logic device 112 can be, for example, a safety switching device that is used in EMERGENCY-OFF devices according to EN 418 and in safety circuits according to VDE 0113 part 1 (11.98) or EN 60 204-1 (11.98), e.g., in the case of movable covers and protective doors. In particular, the logic device 112 can include a safety switching device that, depending on external circuitry, attains category 3 and/or 4 according to DIN EN 954-1.

A safety switching device 112 conventionally has two release circuits 132a, 132b, 134a, 134b (safe circuits) as make contact circuits and auxiliary contactors (logic switching devices) 126, 128 connected to the release circuits. The logic switching devices 126, 128 can be electromagnetic relay devices. Additionally, the safety switching device 112 includes a logic element 140 including logic elements 132, 134 that are coupled to logic contact devices 126e, 128e. Upon switch-on, the internal circuit of the safety switching device 112 and the external contactors 126, 128 are checked for correct functioning (sticking or welded contacts). In this respect, reference is made by way of example to the above description of the interlock distributor box 58.

If, by way of example, the interlock circuit of the interlock distributor box 58 is interrupted, e.g., by the opening of a covering or by a wire breaking, then there is an interruption of the supply voltage at the signal input 114 (see below), preferably approximately 24 V, at the safety switching device 112 and the release circuit (including switches 132a, 132b, 134a, 134b (see below)) of the safety switching device opens safely. As a result, the auxiliary contactors 126, 128 as relays 126, 128 (see below) open circuits 126a, 126b, 126c, 126d and 128a, 128b, 128c, 128d (see below) in redundant fashion. By virtue of the series connection of the switching contacts of relays 126 and 128, turn-off is effected in redundant fashion.

The elements 126a, 126b, 126c, 126d and 128a, 128b, 128c, 128d are make contacts, and the logic contact devices 126e and 128c are break contacts, all of which are positively driven. If, e.g., the auxiliary contactor 126a sticks, the logic contact device 126e remains open and, as a result, logic elements 132 and 134 are not driven.

The safety switching device 112 has one signal input 114 and two signal outputs 116, 118. Furthermore, the safety switching device 112 has a connecting location 120 for connection to the two logic contact devices 126e, 128e. The logic contact devices 126e, 128e can be conventional electrical switches or contacts.

The logic contact devices 126e, 128e are connected to the switches 126a and 128a of the first RF generator 130a in positively driven fashion. In other words, there can be a mechanical connection present between the switch 126e and the switch 126a, such that, if the switch 126e is opened, the switch 126a is closed. Analogously, between the switch 128e and the switch 128a there can be a mechanical or electrical, in particular electromagnetic, connection such that, if the switch 128e is opened, the switch 128a is closed.

Furthermore, FIG. 4 illustrates the second RF generator 130b, the third RF generator 130c, and the fourth RF generator 130d. The RF generator 130b has switches 126b, 128b; the RF generator 130c has switches 126c, 128c; and the RF generator 130d has switches 126d, 128d. The switches 126a, 126b, 126c, 126d are preferably connected to one another in positively driven fashion, that is, the switches 126a, 126b, 126c, 126d can only be opened and closed jointly. Likewise, the switches 128a, 128b, 128c, 128d are connected to one another in positively driven fashion. If the logic contact device 126e, that is, the switch 126e of the logic device 110 is therefore opened, the switches 126a, 126b, 126c, 126d are all closed jointly, and vice versa.

FIG. 4 also shows the switch 132a and the switch 132b of the release circuit. The switches 132a, 132b are connected to one another in positively driven fashion.

Furthermore, FIG. 4 shows the switch 134a and the switch 134b of the release circuit. The switches 134a and 134b are connected to one another in positively driven fashion. Moreover, the switches 132a, 134a are connected to the signal output 116. If the switches 132a, 134a are closed, a signal can be passed through the signal output 116 to the first logic switching device (for example, the first relay) 126. It likewise holds true for the switches 132b, 134b that, if they are closed, a signal can be output through the second signal output 118 to the second logic switching device (for example, the second relay 128).

The relay 126 is in contact with one of the switches 126a, 126b, 126c, 126d in such a way that the relay 126 can actuate the switch. In other words, a signal is output through the signal output 116 to the relay 126 and the relay is thereby converted from an active state to an inactive state or from an inactive state to an active state. Correspondingly, the switch coupled thereto, for example the switch 126a, is opened or closed. Consequently, the switches 126b, 126c, 126d connected to the switch 126a in positively driven fashion are likewise opened or closed. The same applies to the relay 128 and to the switches 128a, 128b, 128c, 128d in an analogous manner. Furthermore, the switches 132a and 132b are connected to one another in positively driven fashion. The switches 134a and 134b are likewise connected to one another in positively driven fashion. If the switch 132a, for example, is closed, the switch 132b is also closed. In the same way, it holds true for the switches 134a and 134b that, if the switch 134a is closed, the switch 134b is also closed, and vice versa. The activation of the switches 132a, 132b, 134a, 134b is carried out by the logic element 140 of the logic device 112.

The first and/or the second relay 126, 128 can be or can include a conventional auxiliary contactor with positively driven contacts. Contactors or contactor switches are, for example, electromagnetically actuated switches that are switched on by the control current of a solenoid and held in their switched-on position. In this case, the movable contact members fitted to the armature are pressed against fixed contact members. These contacts are used to switch loads with relatively high powers such as, e.g., motors or lighting systems.

Auxiliary contactors (for example, 126a, 126b, 126c, 126d, 128a, 128b, 128c, 128d) are electromagnetically actuated switches that are used for switching so-called auxiliary circuits such as, e.g., indication devices, interlocks, controllers, etc. The contactors 126a, 126b, 126c, 126d, 128a, 128b, 128c, 128d are also referred to as power interrupters.

The construction and the functioning of a contactor are described by way of example below. A contactor is a switch that is actuated electromagnetically. It includes a housing, a solenoid, a stationary coil core, a movable armature, the switching contacts and also armature restoring springs.

If voltage is applied to the coil, then a magnetic field builds up. The armature is pulled in. As a result, depending on the embodiment the contacts are either closed (make contact) or opened (break contact). If the voltage is removed, then the armature drops out again and the armature restoring springs bring the contacts to the initial position again. Contactors are constructed, for example, with actuation voltages (coil voltages) of 24 V, 42 V, 60 V, 115 V, 125 V, 230 V, 400 V, and 500 V (preferably at 50 Hz).

Positively driven contacts such as are defined, for example, in the standard EN 50205 or IEC 60947 are described below. The aforementioned standards and definitions contained therein are in this respect an integral part of the application. In the case of positively driven contacts of a relay/contactor, break contacts and make contacts are not closed simultaneously over the service life. This applies even to the defective state of the relays/contactors. If a make contact is welded, for example, then all other break contacts of the affected relay/contactor remain open, irrespective of whether or not the relay/contactor is excited.

In addition, FIG. 4 illustrates the indication contacts 142a to 142h. The indication contacts 142a to 142h are connected in series with one another. Furthermore, FIG. 4 illustrates a power supply in the form of a power supply unit 144 for operating the control apparatus 110 and/or the indication contacts 142a to 142h.

The signal input 114 of the control apparatus 110 is connected, on the one hand, to the negative terminal of the power supply unit 144, that is, to the earth potential. The other terminal of the signal input 114 is connected to the positive contact of the power supply unit 144 through the series-connected indication contacts 142a to 142h. If all the indication contacts 142a to 142h are functional and closed, a current can flow through the indication contacts and can be detected by the logic device 112 by means of the signal input 114. In this case, a check is made to determine whether the switches 126e, 128e are open or closed. If the switches 126e, 128e are also closed, the switches 126a to 126d and the switches 128a to 128d are open, and the switches 132a and 134a are activated. On account of the positive driving, the switches 132b and 134b are also activated, that is, closed. Consequently, a current flows through the relays 126, 128 by means of the signal outputs 116, 118. The relays 126, 128 are thus activated to close the contacts 126a and 128a. Correspondingly, on account of the positive driving, the further contacts 126b, 126c, 126d and the contacts 128a, 128b and 128c are closed. What is thereby achieved is that the RF generators 130a to 130d can be supplied with current and can output a corresponding RF signal.

If, by way of example, at least one of the indication contacts 142a to 142h is opened, the current flow at the signal input 114 is also interrupted. This interruption can be detected by the logic element 140. It is possible for a preferably small auxiliary current to flow through the signal input 114 and the indication contacts 142a-142h and for a change in the current flow or an interruption of the current flow to be detected. On account of this state change of one of the indication contacts 142a-142h, the release contacts 132a and 134a are opened and the release contacts 132b and 134b are also opened correspondingly, on account of the positive driving Consequently, a current supply of the relays 126, 128 is interrupted, whereby the switches 126a and 128a are opened. The switches 126a to 126d and the switches 128a to 128d are likewise opened on account of the positive driving. The current supply of the RF generators 130a to 130d is therefore interrupted and an RF voltage is no longer output. The contacts 126e, 128e are closed on account of the positive driving.

If the open indication contact of the indication contacts 142a-142h is closed again, the RF generators 130a to 130d can also be operated again since the logic device 112 enables the closing of the switches 126a-126d and of the switches 128a-128d.

It is also possible for one or more of the switches 126a-126d or of the switches 128a-128d to be defective. If, for example, the operation of the relays 126, 128 is interrupted because one of the indication contacts 142a-142h opens, the switches 126a-126d and the switches 128a-128d normally open. A defect of the switches 126a-126d or of the switches 128a-128d can consist in the switch 126b, for example, remaining closed on account of sticking or welding. The switches 126a, 126c, and 126d also remain closed on account of the positive driving. The switch 126e of the control apparatus 110 remains open correspondingly on account of the positive driving. A current supply of the RF generators 130a-130d is not possible since the switches 128a-128d are open. If a signal is then applied to the signal input 114, for example, if all the indication contacts 142a to 142h are operational again, it is desirable for the RF generators 130a to 130d also to be operated again. This can be applicable, e.g., if a previously open indication contact of the indication contacts 142a to 142h is closed again. The logic element 140 of the safety switching device 112 detects, however, that a current flow through the connecting location 120 is not possible because the switch 126c is open. In this case, the logic element 140 prevents the contacts 132a, 132b, 134a, 134b from being closed, whereby the relays 126, 128 are not operated either. Consequently, the switches 128a to 128d are not closed. The RF generators 130a-130d are therefore not operated, even though the switches 126a-126d are closed.

Only if the defective, that is, for example, the stuck or welded switch 126b is exchanged and the switches 126a to 126b are therefore all open can a current flow through the contact location 120 be possible again, and such current flow is detected by the logic element 140. Afterwards, by the closing of the switches 132a, 132b, 134a, 134b, the relays 126, 128 are activated and all the switches 126a-126b and 128a-128b are closed. Consequently, the RF generators 130a to 130b are supplied with current again and RF voltage or RF signal is output.

The above explanations also apply analogously to the switches 128a-128d, that is, if one or a plurality of switches 128a-128d is defective.

Furthermore, the number of RF generators can be increased or decreased. Correspondingly, a plurality of pairs of signal outputs can be arranged in the control apparatus and drive different groups signal outputs of different groups of RF generators. Correspondingly, a larger or smaller number of indication contacts 142a to 142h can be present, in which case subsets of the indication contacts can be subdivided into groups. The indication contacts of each group can be connected in series, for example. The indication contacts of the different groups can be connected to the control apparatus 110 at different signal inputs. Likewise, a plurality of groups of switches 132a, 132b, 134a, 134b can be present according to the number of signal inputs, that is to say according to the number of groups of indication contacts. The same applies to the logic contact device 126e, 128e and to the contact location 120. A multiplicity of contact locations 120 can be present in a manner corresponding to a multiplicity of groups of plasma power supply devices.

As an alternative, a power supply system can also have a plurality of control apparatuses 110, where the control apparatuses are in each case designed to control a group of RF generators or to come into contact with a group of indication contacts.

Furthermore, it is possible, for example, for one or a plurality of the relays 126, 128 to be integrated into one of the RF generators 130a-130d and for the relay or relays to be supplied with current through the signal outputs 116, 118 in order to close the contacts 126a-126d, 128a-128d.

In other implementations, indication contacts can be associated with a switchgear cabinet in which the RF generator is accommodated such that the RF generator would not supply voltage if the switchgear cabinet is opened.

The indication contacts can be fitted to doors, flaps, or similar openings of a housing of the plasma chamber, a housing of the RF generator, or a housing of the impedance matching devices, or a switchgear cabinet of the RF generator.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A plasma power supply controller for jointly monitoring a plurality of plasma power supply devices of one or more electrical loads, the controller comprising:
at least one signal input, wherein the at least one signal input is configured to receive indication signals of at least one indication device;
at least one signal output connected to at least one first logic switching device configured to actuate a first power interrupter of at least one of the plasma power supply devices; and
a safety switching device configured to detect a state or a state change of at least one of the indication devices and to interrupt the current supply of at least one of the plasma power supply devices using the first logic switching device upon a detection of a predetermined state or upon a detection of a state change of at least one of the indication devices.

2. The controller of claim 1, wherein the at least one first logic switching device actuates by opening or closing the first power interrupter.

3. The controller of claim 1, further comprising a further signal output connected to at least one second logic switching device configured to actuate a second power interrupter of at least one of the plasma power supply devices.

4. The controller of claim 3, wherein at least one of the logic switching devices comprises an electromagnetic relay.

5. The controller of claim 3, wherein the at least one second logic switching device actuates by opening or closing the second power interrupter.

6. The controller of claim 1, further comprising at least one group of signal outputs, wherein each signal output of the group of signal outputs includes a signal interrupter, and wherein the signal interrupters of the group of signal outputs are connected to one another in a positively driven fashion.

7. The controller of claim 6, wherein:
the safety switching device is connected to at least one first logic contact device, and
the at least one first logic contact device is configured to be connected to at least one first power interrupter of at least one plasma power supply device in a positively driven fashion.

8. The controller of claim 7, wherein the safety switching device comprises a first logic contact device and a second logic contact device for each group of signal outputs.

9. The controller of claim 7, wherein:
the safety switching device is connected to at least one second logic contact device, and
the second logic contact device is configured to be connected to at least a second power interrupter of at least one plasma power supply device in a positively driven fashion.

10. The controller of claim 6, wherein the safety switching device is configured to detect a state of the at least one first and/or second logic contact device upon the start-up of the control apparatus and to prevent a state change of the logic switching device upon a detection of a predetermined state of the at least one first and/or second logic contact device.

11. The controller of claim 10, wherein the safety switching device is configured to prevent a state change of one or more of the signal interrupters of one of the groups of signal outputs upon detection of a predetermined state of the at least one logic contact device.

12. The controller of claim 11, wherein the safety switching device is configured to selectively select a group of signal outputs and to prevent a state change of the signal interrupters of the selected group of signal outputs upon detection of a predetermined state of the at least one logic contact device.

13. A plasma power supply system comprising:
at least two plasma power supply devices connectable to supply power to at least one electrical load, and
a controller configured to jointly monitor the at least two plasma power supply devices, wherein the controller comprises:
at least one signal input, wherein the at least one signal input is designed to receive indication signals of at least one indication device,
at least one signal output connected to at least one first logic switching device configured to actuate a power interrupter of at least one of the plasma power supply devices, and
a safety switching device configured to detect a state or a state change of at least one of the indication devices and to interrupt the current supply of at least one of the plasma power supply devices using the first logic switching device upon detection of a predetermined state or upon a detection of a state change of one of the indication devices.

14. The plasma power supply system of claim 13 wherein the at least one first logic switching device is configured to actuate by opening or closing the first power interrupter.

15. The plasma power supply system of claim 13, wherein the controller includes at least one second signal output connected to at least one second logic switching device, wherein the second logic switching device is configured to actuate a second power interrupter of at least one of the power supplies.

16. The plasma power supply system of claim 15, wherein the at least one second logic switching device is configured to actuate by opening or closing the second power interrupter.

17. The plasma power supply system of claim 15, wherein:
the controller includes at least one group of signal outputs,
each signal output of the group of signal outputs has a signal interrupter, and
the signal interrupters of the group of signal outputs are connected to one another in a positively driven fashion.

18. The plasma power supply system of claim 17, wherein the plasma power supply devices include a group of plasma power supply devices that each have at least one first power interrupter connected to one another in a positively driven fashion.

19. The plasma power supply system of claim 18, wherein the safety switching device has at least one first logic contact device and the first logic contact device is connected to the first power interrupters of the group of plasma power supply devices in a positively driven fashion.

20. The plasma power supply system of claim 19, wherein the first power interrupters of the group of plasma power supply devices are connected to one another and to the first logic interrupting device of the safety switching device in a positively driven fashion in such a way that the first logic interrupting device of the safety switching device is opened in the event of a defective first power interrupter.

21. The plasma power supply system of claim 19, wherein the safety switching device has at least one second logic contact device and the second logic contact device is connected to the second power interrupters of the group of plasma power supply devices in a positively driven fashion.

22. The plasma power supply system of claim 13, further comprising two or more matching devices configured to match a power output of at least one of the plasma power supply devices to the at least one of the electrical loads, wherein each matching device comprises at least one indication device.

23. The plasma power supply system of claim 13, further comprising a matching device designed to match a power output of at least one of the plasma power supply devices to the at least one of the electrical loads, wherein the matching device comprises two or more indication devices.

24. The plasma power supply system of claim 13, wherein the safety switching device and the at least one indication device are connected to one another in such a way that the indication device transmits the state information digitally to the safety switching device.

25. The plasma power supply system of claim 24, wherein the indication device is configured to transmit a signal continuously, and wherein the safety switching device is designed to detect a state change if the transmitted signal is interrupted.

26. The plasma power supply system of claim 13, further comprising two or more impedance matching devices configured to match output signals of the two or more RF generators in such a way that the output signals are matched as input signals of a plasma chamber comprising one or more electrodes for plasma generation.

27. A method of jointly monitoring a plurality of plasma power supply devices, the method comprising:
monitoring a state of at least one indication device,
detecting a predetermined state and/or a state change of the at least one indication device with a safety switching device,
changing the state of a first logic switching device by means of the safety switching device if a predetermined state and/or a state change of the at least one indication device has been detected, and
changing a state of a power interrupter of at least one of the plasma power supply devices on the basis of the state change of the first logic switching device such that a current supply of at least one of the plasma power supply devices is interrupted.

28. A computer program product, which, when loaded in and executed by a computer, has the effect that the computer carries out a method according to claim 27.
